(19) United States
(12) Patent Application Publication
(10) Pub. No.: US 2002/0019944 A1
(43) Pub. Date: Feb. 14, 2002

(54) Method and system for granting acces to information for electronic commerce

(75) Inventor: Weidong Kou, Pokfulam (HK)

Correspondence Address: Gerald R. Woods, IBM Corporation T81/503, PO Box 12195, Research Triangle, Park, NC, 27709, US

(73) Assignee: International Business Machines Corporation, Armonk, NY (US)

(21) Appl. No.: 09/873,967

(22) Filed: Jun. 4, 2001

(30) Foreign Application Priority Data
Aug. 14, 2000 (CA) 2315933

(51) Int. Cl. H04L 9/00

(52) U.S. Cl. 713/200; 713/171

(57) ABSTRACT

To reduce the number of key pairs that must be managed in an asymmetric encryption/decryption system, each customer of a vendor is assigned to at least one defined customer group as a function of the information that is to be made available to the customer. A key pair consisting of a group source key and a group member key is assigned to each defined customer group. The vendor uses the group source key to encrypt information to be made available only to members of the associated group. Authenticated customers are given the group member key for each group to which they belong. The customers use the group member key to decrypt information previously encrypted by the vendor using the associated group source key.

### FIELD OF THE INVENTION

The present invention relates to a method and a system for granting access to information to customers over a communications network, and more specifically to a method and system for granting access to group-targeted, protected information to members of customer groups over a network of computing devices.

### BACKGROUND OF THE INVENTION

For an e-commerce vendor, the ability to grow and respond quickly is a distinctive and important business advantage in today's fast-moving marketplace. The pressure to respond quickly is driven by many factors, such as: identifying new business opportunities, improving customer service, reducing purchasing and sales costs, and reducing inventories. The vendor must continuously strive to improve business and technological issues that surround granting access to information. Maintaining a leading position within the marketplace requires a vendor to establish and refine effective business models to increase profits, and ensure trusted and secured financial transactions and exchange of confidential information.

It is an important competitive advantage to be able to quickly and easily grant selected or controlled access to confidential information to customers over a communications network such as the Internet. For example, to overcome a short-term competitive threat, a vendor may need to quickly provide information to customers where the information may be time-sensitive or valid for specific market conditions. Content of the information could represent negotiated pricing, discounted pricing, important notices such as press releases, or warranty information. Such information may be used to influence purchasing decisions of customers or to quickly manage requests from many prospective customers via the Internet, while minimizing computing hardware configuration and cost.

Protecting information can be accomplished by using symmetric encryption in which a single key is used both for encrypting and decrypting information, or asymmetric encryption based on public-private key pair cryptography in which a public key is used for encrypting information and a private key is used for decrypting encrypted information. However, a significant problem occurs in using keys when many keys must be managed. Certificate Authorities (CAs) are used to register and contain public keys that belong to users. A user registers with a CA to obtain a certificate that contains the public key of the user. A certificate is digitally signed by a CA, which is subsequently placed into a public directory, such as a CCITT X.500 directory. Typically, a CA manages a directory. When user A wants to send a confidential electronic message to user B, user A locates a certificate that belongs to user B by examining a directory; then, user A encrypts a message by using a public key that belongs to user B, in which the public key can be found in a certificate that belongs to user B. Then, user A sends an encrypted message to user B. Only user B has access to a private key that belongs to user B, in which the private key is used to decrypt the encrypted message. It is understood that all private keys remain inaccessible to nonowners to ensure message security, while all public keys are shared. In an e-commerce application, a vendor cannot assume that customers are registered with a CA. In addition, CAs may not wish to share directories with other CAs. Since a public key infrastructure may not be available, a vendor may have to directly manage keys for customers. Assigning a unique pair of keys to each customer would require managing a very large number of keys, which would require additional processing effort and additional computer hardware when attempting to manage many requests for access to information.

Sirbu et al—in U.S. Pat. No. 5,809,144 “Method and Apparatus for Purchasing and Delivering Digital Goods over a Network” dated Sep. 15, 1998—discloses a method for purchasing and delivering digital goods over a network. This reference apparently uses symmetrical encryption which requires managing a very large number of keys (one key is used per delivered electronic document). This reference apparently suggests that a vendor must use a different key each time a new document is delivered to a customer to prevent the customer from opening the new document by using a previously received key. A significant number of keys would be required since each unit of information is individually protected. It would be a significant advantage and improvement if a solution could use a small number of keys for protecting information for access by a very large number of customers.

Carter—in U.S. Pat. No. 5,787,175 “Method and Apparatus for Collaborative Document Control” dated Jul. 28, 1999—discloses a method for distributing a document within a class of authorized users by enabling access of the document from within a portion of the document in which the users encrypt and decrypt portions of the document and each user has a unique public-private key pair. This reference apparently uses a very large number of keys to grant access to information to a significantly large number of customers.

Linehan et al—in U.S. Pat. No. 5,495,533 “Personal Key Archive” dated Feb. 27, 1996—discloses a method for managing encryption keys that are used for encrypting data files. This reference apparently uses symmetric encryption keys such that each key is correspondingly assigned to a document for which a dedicated key server automatically manages all of the keys for the documents and the documents are managed by a document server. This reference apparently requires using additional computer hardware configurations. It would be a significant advantage to use a minimal number of keys to minimize hardware configuration and processing effort required for granting access to information to a significantly large number of customers.

Hass et al—in U.S. Pat. No. 5,719,938 “Methods for Providing Secure Access to Shared Information” dated Feb. 17, 1998—discloses a method for using symmetrical cryptographic systems. This reference apparently requires a vendor to manage a very large number of encryption keys, and to create encrypted information for each customer every time a customer requests access to information. This reference apparently presents a significant processing burden when attempting to manage a large number of customers, which would be a disadvantage when attempting to respond quickly to fast-changing marketplace conditions.

Lohstroh et al—in U.S. Pat. No. 5,953,419 “Cryptographic File Labelling System for Supporting Secured Access by Multiple Users” dated Sep. 14, 1999—discloses a method for protecting data by assigning one key per user. Each authorized user uses a unique private key to gain access to encrypted portions of the file. This reference apparently requires generating and managing a significantly large number of keys for granting access to information to a large number of customers.

A good solution should enable a vendor to quickly and easily grant access to protected information to many customers while minimizing computer requirements and processing effort.

### SUMMARY OF THE PRESENT INVENTION

One aspect of the present invention provides a method and a system for managing access to information in a catalog to customers over a network while protecting the information and reducing computing effort and hardware requirements. Protection preferably includes encryption such as key-based cryptography and the like for preventing unauthorized access to information. Another aspect of the present invention also reduces effort for managing information by classifying customers into groups in accordance with a type of relationship a vendor wishes to define with members of a group and creating information that is assigned to specific groups of customers.

The present invention manages access to information by establishing groups of customers, which would be relatively small in number compared to a total number of customers, and controlling protected information by group as will be explained hereunder.

A preferred embodiment of the present invention provides a controlled access catalog listing catalog items accessible by members of authorized groups. The catalog includes: identification of authorized groups; identification of selected catalog items and group information for the authorized groups; a group source (GS) key unique to each authorized group for encrypting information intended only for that group; a group member (GM) key available to each member of an authorized group for decrypting encrypted group information, the GM key corresponding respectively to the GS key of the same group; and an authenticator for controlling access to the GM keys of authorized groups.

Preferably the authenticator, typically implemented in software, is responsive to receiving member identification for granting access to the GM key of an authorized group. For providing restricted access to pricing, the group information may include group pricing.

The catalog can include identification of members of each authorized group to be used in authentication. An encryptor such as encryption software can be used for encrypting the group pricing by using the GS key.

An access interface can be provided for accessing the encrypted group pricing of authorized groups by their members. The access interface is responsive to a member providing identification and authentication data for confirming authorization to access encrypted group pricing.

In another implementation, a multinodal information-handling network includes the catalog at a node of the network.

A user interface is provided at another node of the network, the user interface includes: an input for accepting member input, including member identification and authentication data; and, a communication interface for sending member input to the catalog over the network.

The communication interface is preferably adapted to receive information output from the catalog including identification of catalog items and decrypted group pricing. The user interface includes a display, for a user, to view identification and pricing of catalog items. The display can be used to present to a user: an input screen having an input field for the user to enter a query including member identification and authentication data to be sent to the catalog by the communication interface to request access to the catalog; and, a user presentation screen to display information including decrypted pricing of catalog items available to the user after access to the catalog has been communicated to the communication interface.

Another aspect of the present invention provides a method for managing a controlled access catalog for storing identification of catalog items accessible by members of authorized groups by: storing identification of authorized groups; storing identification of selected catalog items and group information for authorized groups; encrypting group information with a group source or GS key unique to each authorized group; storing a group member or GM key for each authorized group for decrypting encrypted group information, the GM key corresponding to the GS key of each authorized group; and, authenticating and granting access to the GM key of an authorized group for decrypting encrypted group information intended for members of that authorized group.

The step of authenticating is preferably responsive to receiving member identification, for granting access to the GM key of an authorized group.

The method can include decrypting encrypted group pricing using a GM key of an authorized group when pricing information is requested by an authenticated member of the authorized group.

The identity of members of an authorized group can preferably be stored in the catalog.

The method of the invention can include: encrypting group pricing of an authorized group by using the GS key of the authorized group; and, providing access to encrypted group pricing of an authorized group in response to a user providing identification and authentication data for confirming authorization of the member to access encrypted group pricing.

Another aspect of the present invention provides a program product having a computer-readable medium for storing computer-readable program code for managing a controlled access catalog accessible by members of authorized groups. The program code includes: computer-readable program code for causing the computer to store identification of authorized groups; computer-readable program code for causing the computer to store identification of selected catalog items and group information, which may include group pricing, for the authorized groups; computer-readable program code for causing the computer to encrypt the group information for each authorized group with a group source or GS key unique to the authorized group; computer-readable program code for causing the computer to store group member or GM keys for the authorized groups for use in decrypting encrypted group information, the GM keys corresponding respectively to the GS keys of the authorized groups; and, computer-readable program code for causing the computer to authenticate and grant access to the GM keys of authorized groups.

The program product may advantageously have computer-readable program code for causing the computer to decrypt encrypted group pricing using a GM key when pricing information is requested by an authenticated member of an authorized group. Additionally, the program product preferably includes: computer-readable program code for causing the computer to encrypt the group pricing of an authorized group by using the GS key of the authorized group; and, computer-readable program code for causing the computer to access the encrypted group pricing of the authorized group by the members, responsive to a member providing identification and authentication data for confirming authorization of the member to access the encrypted group pricing.

### BRIEF DESCRIPTION OF THE DRAWINGS

To illustrate the aspects of the present invention, the following figures are used, in which:

FIG. 1 shows a process for granting a customer (who is a member of an authorized customer group) access to protected pricing information managed in a controlled access catalog;

FIG. 2 shows a flow chart for controlling access to pricing information on a web server, and;

FIG. 3 is a block diagram of a system within which the invention can be implemented.

### TECHNICAL DESCRIPTION

The present invention will be described with reference to an exemplary context of a method and system for granting access to members of customer groups to pricing information that is assigned or intended for viewing by the members of customer groups over a network. The present invention could be adapted to operate over many types of communication networks or to grant access to any suitable type of information.

An information owner or controller such as a vendor may create information that has a pricing content in which pricing information is assigned to specific customer groups such as wholesale pricing for a wholesale customer group. It can be appreciated that the information could be warranty information and the like that is assigned to members of a predetermined customer group. However, for the purposes of describing aspects of the present invention, this example will use information that has a pricing content.

The method of the present invention allows an information owner or a vendor to grant access to pricing information that is assigned to specific groups of members, in which content of the information revealed depends on the group to which a member belongs. Information could reside in software databases and applications that are implemented on web servers or other information handling devices. A preferred embodiment of the present invention uses asymmetrical encryption based on “public-private” key cryptography in which it is preferred that each key pair is correspondingly assigned to a particular customer group. The keys are used to encrypt and decrypt the information. The present invention does not assign a key pair to each customer which might overwhelm something less than complicated computer-hardware configurations.

It can be appreciated that an information provider or a vendor would deal with many different customer groups such as wholesale customers, retail customers and the like. Therefore, it would be advantageous for a vendor to manage pricing information so that specific pricing content is accessible only by members of specific customer groups. There would be many situations in which this is desirable. To show appreciation to loyal or high volume customers, a vendor may want to offer favorable or discounted pricing. To attract new customers, a vendor may want to offer a special one-time or time-limited pricing to new customers. For a large-volume customer which provides a significant portion of a vendor's revenue, the vendor may want to offer mutually negotiated pricing.

Therefore, it is advantageous for a vendor to be able to implement pricing that is structured or targeted to specific groups of customers. A specific group of customers could access to pricing available only to members of their group without exposing the pricing to customers outside the specific group. The strategy would be then to enable a vendor to grant access to group-encrypted, group-targeted pricing along with a group-targeted decryption for decrypting the encrypted pricing.

A vendor begins by defining specific groups of customers into which all of its customers are to be categorized. For example, let N be a number of customer groups in which N=3. A vendor will want to define three pricing strategies for either a product or a range of products. For example, a wholesale pricing strategy is defined for members of a wholesale customer group while a retail pricing strategy is defined for members of a retail customer group, and a most-favored pricing strategy is defined for members of a most-favored customer group. It can be appreciated that it may be possible to assign group-targeted pricing to more than one group which may provide improved flexibility and convenience for managing customer relations. This example is further developed in two scenarios described below.

The first scenario is that a vendor wants to protect all three pricing strategies from unauthorized access from any unregistered customers or any customer not in one of the three defined groups.

The second scenario is that a vendor is willing to make its retail pricing strategy available to anybody who can access the vendor's web sever but while protecting the remaining pricing strategies from unauthorized access.

In the first scenario, customers will be initially required to register with a vendor's web server. Upon successful registration, each customer could be assigned an identification such as an ID and the like, and an authentication device such as a password and the like for identifying and authenticating customers as members of a particular group. Prior to providing access to protected pricing, a vendor assigns each customer to a specific group or to a range of groups so that a customer is a member of at least one group. In this example, a vendor uses three different key pairs in which each key pair is assigned to a customer group. It can be appreciated a key pair could be assigned to more than one group which may provide improved flexibility and convenience for managing customer relations. After performing an identification and authentication step, authenticated members of a group will be given access to the key unique to that group (the group member or GM key) along with group-encrypted, group-assigned pricing. Preferably, before members obtain access to the pricing applicable to their group, the vendor could encrypt specific pricing assigned to each group by using a group source or GS key associated with only one of the defined customer groups. Also, before a customer is granted access to any group-targeted, protected pricing, a web server could identify and authenticate a customer by evaluating the customer's submitted ID and authentication password. It can be appreciated that a unique ID and password could be assigned either to each specific customer or could be assigned to each customer group (i.e., a group-oriented ID and password). After successfully identifying and authenticating a customer, a web server determines to which customer group that a member belongs, and then grants access to encrypted pricing that is available to a group in which a customer is a member; a group member (GM) key that is assigned to a group including the customer to enable the customer to decrypt encrypted pricing.

It is preferable to configure the present invention so that unauthenticated customers are prevented from accessing encrypted pricing or any corresponding decryption key. This could be realized by assigning suitable ID's and passwords and using an appropriate authentication step. It can be appreciated that the present invention could operate without any authentication step but could be improved by including such a step. It is preferable to prevent a member of one group from accessing pricing assigned or targeted for other groups.

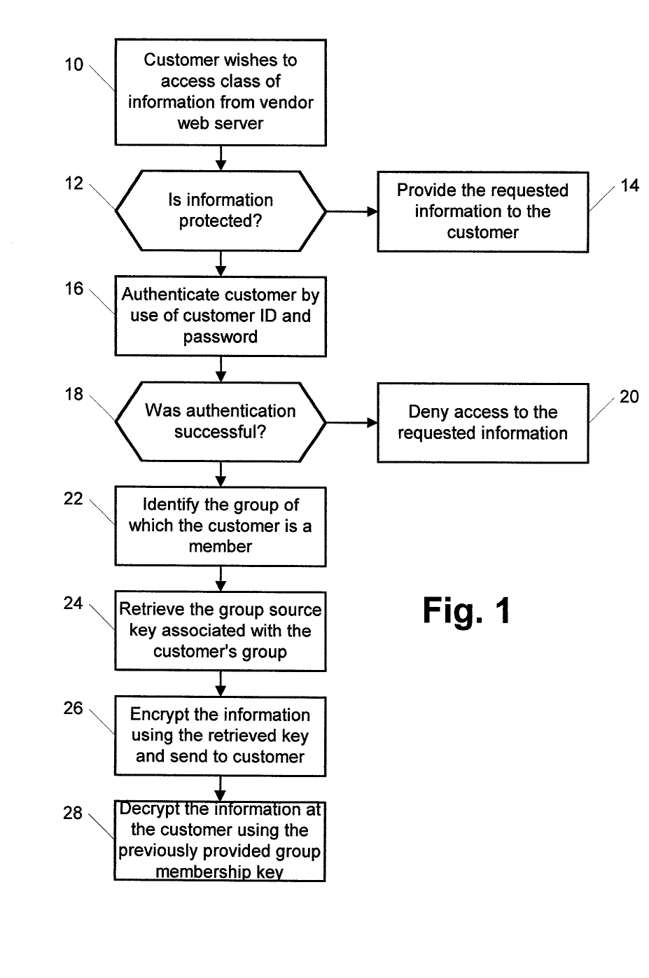

Referring to FIG. 1 which shows how to provide access to pricing (10) under the second scenario, a vendor freely provides retail pricing to anyone (14) that can access the vendor's web server while granting access to pricing (12) assigned to authenticated members (18) of a group after performing an authentication step (16). If the authentication step (16) is not successful, a customer is denied access to encrypted pricing (20). Ideally, pricing available only to members of one group should not be accessible by members belonging to other groups, unauthorized customers, or competitors. The present invention can be further adapted so that members of wholesale and/or favored customer groups are granted access to their group-targeted pricing in which the pricing or decryption key is not made accessible to non-members. Customers are not required to register and authenticate themselves (12, 14); however, customers who are authenticated members of a group could preferably be identified and authenticated (16, 18) prior to granting access to pricing. The present invention determines to which group a customer member (22) belongs. At least two key pairs are required. One key pair is assigned to a first group, such as a wholesale group, while the other key pair is assigned to a second group, such as a favored customer group. Authenticated members of a group are granted access to an assigned group member key (24) along with assigned encrypted pricing (26) so that the group member key can be used to decrypt the encrypted pricing (28).

A vendor avoids generating or managing a unique key pair for every customer by assigning key pairs to groups of customers. Preferably, members of one group should not be able to access granted to the pricing that is targeted and encrypted for other assigned groups.

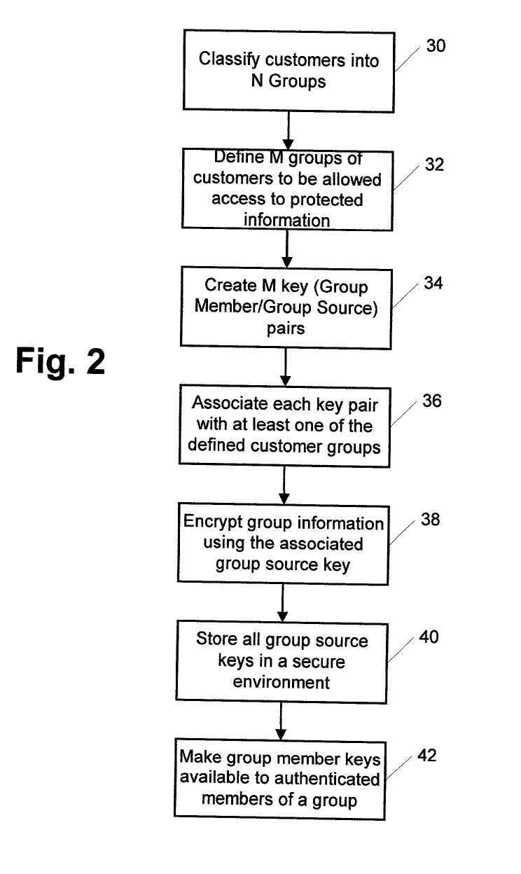

Referring to FIG. 2, the steps require to grant access to group-targeted pricing are illustrated. In a step 30, specific groups of members are defined and all customers are assigned to at least one of the defined groups. In a step 32, a determination is made which groups will have access to encrypted pricing. It is assumed that there are M groups who will be granted access to encrypted pricing. M can be no greater than N and would normally be less then N. A pricing strategy is assigned to each group with the pricing strategy being applicable to at least one product and preferaby to a range of products. Preferably, there are at least a total of M pricing strategies that will be encrypted; however, it can be appreciated that some groups could share a pricing strategy which may improve the management of customer relations. In a step 34, a number of key pairs is created with the number preferably being the same as the number of defined customer groups. In step 36, a particular key pair is associated to one of the customer groups. One of the two keys, identified as a group source or GS key, is used by the vendor in a step 38 to encrypt prices to be made available only to that customer group. All GS keys are retained by the vendor and are preferably stored in a physically and electronically secure environment in a step 40. Finally, in a step 42, the group member or GM key assigned to a particular group is made available to authenticated members of the group so that the GM key can be used to decrypt pricing encrypted by the vendor using the associate GS key. In a preferred environent, decrypted pricing may be displayed by a customer through use of a web browser.

Key management becomes a greatly simplified task since the number of customer groups is usually considerably smaller than a total number of customers. While a vendor may potentially have to manage requests from potentially millions of customers over the Internet, there will be a significantly smaller number of customer groups that will be relatively easier to manage.

It can be appreciated that the present invention can be further adapted to be incorporated in a computer program that contains executable software instructions for implementing the concepts of the present invention in which the program can be used on a general purpose computer or a web server over a communications network such as the Internet. It can be appreciated that a distribution mechanism can be used to distribute the computer program in which the distribution mechanism allows the vendor to access the computer program. The distribution mechanism or media could be a computer media such as a floppy disk, compact disk, and the like. Additionally, the distribution mechanism could be software instructions that can be downloaded over a network, such as the Internet in which the downloaded instructions incorporate the software instructions that execute the concepts of the present invention.

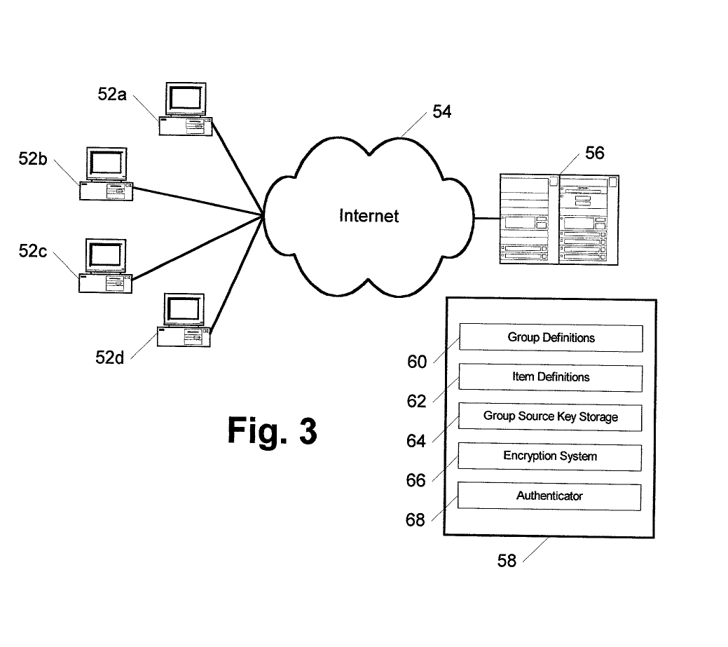

FIG. 3 is a simplified view of a network of the type in which the present invention can be implemented. A number of independent users or customers, represented by workstations 52a-52d, can communicate with a vendor, represented by a computer system 56, by using web browsers at the workstations and a wide area network 54, such as the Internet. Even if all of the customers use the same type of workstation and have the same type of internet service, from the vendor's perspective, those customers can be categorized or classified into different groups to who different sets of information may be made available in accordance with the present invention.

The invention requires that the vendor maintain certain data structures in a catalog or database 58, including the group definitions (including which customers are members of which groups and item or information definitions (including which of the groups is to be allowed access to each item). The vendor also must maintain secure storage 64 for the group source or GS keys associated with the different defined groups. Further, the vendor must include an encryption system 66 which is used to encrypt information using the group source keys. Finally, the vendor typically needs an authenticator system 68, which is used to authenticate the identity of a requesting customer before releasing information to that customer.

It can be appreciated that the concepts of the present invention can be further extended to a variety of other applications that are clearly within the scope of this invention in which users or customers can access many types of assigned information such as press releases, temporary pricing, warranty information and the like, in addition to or instead of pricing information.

Having thus described the present invention with respect to a preferred embodiment as implemented for granting access to group-targeted pricing information to members of groups, it will be apparent to those skilled in the art that many modifications and enhancements are possible to the present invention without departing from the basic concepts as described in the preferred embodiment. Therefore, what is intended to be protected by way of letters patent is set forth in the following claims.

What is claimed is:

1. A system for controlling access to information items comprising:
a) a storage subsystem containing definitions of customer groups, customer information including which customer group or groups to which each customer belongs, information item definitions including which customer group or groups with which each information item is associated, a set of group source keys, each group source key being associated with a different one of the customer groups, a set of group member keys, each group member key being associated with a different one of said group source keys;
b) an encryption subsystem for encrypting information items information items associated with a customer group using the group source key associated with the same group; and
c) an authentication subsystem for allowing a customer access to a group member key once the customer has been authenticated as a member of the customer group with which the group member key is associated, thereby enabling the customer to use the group member key to decrypt item information previously encrypted using the associated group source key.

2. A system as defined in claim 1 wherein the authentication subsystem further includes:
a) an authentication storage subsystem for storing customer identifiers and associated passwords; and
b) authentication logic for receiving customer identifier and password inputs, comparing the received inputs to stored customer identifiers and associated passwords, and authenticating the inputs provider when the inputs matched the stored corresponding information.

3. A system as defined in claim 1 wherein the information items include pricing information.

4. A system as defined in claim 2 wherein the information items including pricing information.

5. A method for controlling access to information items comprising the steps of:
a) storing definitions of customer groups;
b) storing customer information including which customer group or groups to which each customer belongs;
c) storing information items including which customer group or groups with which each information item is associated;
d) storing sets of key pairs, each key pair being associated with one of the defined customer groups and comprising a group source key and a group member key;
e) encrypting at least one information item using the group source key for the group with which the information item is associated; and
f) providing the group member keys to customer members of the groups with which the group member keys are associated, thereby enabling a customer to decrypt an encrypted information item associated with the customer's group.

6. A method as defined in claim 5 wherein the stored customer information includes customer identifiers and passwords and wherein the providing step further includes the steps of:
a) receiving customer identifier and password inputs;
b) comparing the received inputs to stored customer identifiers and passwords;
c) responding to a match between the received inputs and a stored customer identifier and password by identifying the customer as having been authenticated; and
d) making available the group member key associated with a customer group to which the authenticated customer belongs.

7. A program product having a computer-readable medium storing computer-readable program code for controlling access to information items, said computer-reable program code comprising:
a) code for causing the storage of definitions of customer groups;
b) code for causing the storage of customer information including which customer group or groups to which each customer belongs;
c) code for causing the storage of information items including which customer group or groups with which each information item is associated;
d) code for causing the storage of sets of key pairs, each key pair being associated with one of the defined customer groups and comprising a group source key and a group member key;
e) code for encrypting at least one information item using the group source key for the group with which the information item is associated; and
f) code for providing the group member keys to customer members of the groups with which the group member keys are associated, thereby enabling a customer to decrypt an encrypted information item associated with the customer's group.

8. A program product as defined in claim 7 wherein the stored customer information includes customer identifiers and passwords and the program product further includes:
a) code for receiving customer identifier and password inputs;
b) code for comparing the received inputs to stored customer identifiers and passwords;
c) code responsive to a match between the received inputs and a stored customer identifier and password to identify the customer as having been authenticated; and
d) code responsive to the authentication to make available the group member key associated with a customer group to which the authenticated customer belongs.
